(19) United States
(12) Patent Application Publication
(10) Pub. No.: US 2025/0006397 A1
(43) Pub. Date: Jan. 2, 2025

(54) HYBRID ARCHITECTURE FOR QUANTUM OBJECT CONFINEMENT APPARATUS

(71) Applicant: Quantinuum LLC, Broomfield, CO (US)

(72) Inventors: David L. Hayes, Broomfield, CO (US); Alexander Chernoguzov, Warrington, PA (US); Curtis Volin, Marietta, GA (US); Russell P. Stutz, Broomfield, CO (US); John Pagnucci Gaebler, Golden, CO (US); Christopher E. Langer, Highlands Ranch, CO (US)

(21) Appl. No.: 18/527,998

(22) Filed: Dec. 4, 2023

Related U.S. Application Data
(60) Provisional application No. 63/504,808, filed on May 30, 2023.
(60) Provisional application No. 63/476,226, filed on Dec. 20, 2022.

(51) Int. Cl. G21K 1/00; G06N 10/40; H01J 49/42

(52) U.S. Cl. CPC G21K 1/00; G06N 10/40; H01J 49/422

(57) ABSTRACT

A confinement apparatus is provided that includes one or more sorting sections and an operation section. Each sorting section comprises a plurality of sorting section radio frequency (RF) rails that are configured to, when a sorting RF voltage is applied thereto, define a plurality of sorting confinement regions configured for confining quantum objects. Each sorting section RF rail has a sorting thickness in a direction perpendicular to a longitudinal axis of the sorting section RF rail. The operation section comprises a plurality of operation section RF rails that are configured to, when an operation RF voltage is applied thereto, define a plurality of operation confinement regions configured for confining the quantum objects. Each operation section RF rail has an operation thickness in a direction perpendicular to a longitudinal axis of the operation section RF rail. The operation thickness is larger than the sorting thickness.

### CROSS-REFERENCE TO RELATED APPLICATIONS

This application claims priority to U.S. Application No. 63/504,808, filed May 30, 2023, and U.S. Application No. 63/476,226, filed Dec. 20, 2022, the contents of which are incorporated herein by reference in their entireties.

### TECHNICAL FIELD

Various embodiments relate to quantum object confinement apparatuses having hybrid architectures. For example, various embodiments relate to quantum object confinement apparatuses and system comprising quantum object confinement apparatuses comprising multiple sections, where each section is configured for performance of a different class of functions.

### BACKGROUND

In various scenarios, a system may be configured to perform multiple functions and different functions may have different tolerances (e.g., in the noise present in the signals applied to various electrical components of the system) and/or different function-specific operating parameters. For example, an ion trap can use electric potential to capture a plurality of ions in one or more respective potential wells. Various functions may be performed to cause the ions to move in particular ways through portions of the ion trap and/or be contained in a particular portion of the ion trap. These various functions may have differing noise tolerances in the signals used to generate the electric potentials. Through applied effort, ingenuity, and innovation, many deficiencies of such prior systems have been solved by developing solutions that are structured in accordance with the embodiments of the present invention, many examples of which are described in detail herein.

### BRIEF SUMMARY OF EXAMPLE EMBODIMENTS

Example embodiments provide quantum object confinement apparatuses, systems comprising quantum object confinement apparatuses, and methods for operating systems comprising quantum object confinement apparatuses that have hybrid architectures. In various embodiments, a quantum object confinement apparatus (also referred to herein as a confinement apparatus) comprises two or more sections where each section is configured for performing a particular class of functions on quantum objects confined thereby. For example, in various embodiments, the confinement apparatus comprises a sorting section configured for performing sorting and storing functions on quantum objects confined within a sorting section. In various embodiments, the confinement apparatus comprises a quantum operation section (also referred to herein as an operation section) configured for performing quantum operations therein. In various embodiments, the quantum operations include single or multi-qubit (e.g., two-qubit) quantum logic gates, entanglement operations, reading and/or measurement operations, shelving/de-shelving operations, sympathetic laser cooling operations, and/or other operations where one or more quantum objects are interacted with an external field (e.g., magnetic field, magnetic field gradient, laser beam(s)/pulse(s), microwaves, and/or the like).

In various embodiments, the geometry and/or operating parameters of a sorting section are different from the geometry and/or operating parameters of an operation section. For example, a sorting confinement region of a sorting section may be configured to confine quantum objects closer to the surface of the confinement apparatus than an operation confinement region of an operation section. For example, the noise tolerances of a sorting section may be different from the noise tolerances of an operation section, and/or the like.

In various embodiments, a transition zone is disposed between sections configured for performance of different classes of functions. For example, a transition zone is disposed between a sorting section and an operation section, in an example embodiment. In various embodiments, a transition zone is an area or portion of the confinement apparatus where the geometry of the confinement apparatus and/or operating parameters of the confinement apparatus transition between the sections connected by the transition zone. In various embodiments, the transition between the geometry and/or operating parameters within the transition zone is configured such that a quantum object traversing the transition zone from a first section to a second section (e.g., from a sorting section to an operation section or vice versa) experiences the change in geometry and/or operating parameters in an adiabatic manner.

According to one aspect of the present disclosure, a quantum object confinement apparatus is provided. In an example embodiment, the quantum object confinement apparatus comprises one or more sorting sections, and an operation section. Each sorting section of the one or more sorting sections comprises a plurality of sorting section radio frequency (RF) rails. The plurality of sorting section RF rails is configured to, when a sorting RF voltage is applied thereto, define a plurality of sorting confinement regions configured for confining quantum objects. Each sorting section RF rail of the plurality of sorting section RF rails has a sorting thickness in a direction perpendicular to a longitudinal axis of the sorting section RF rail. The operation section comprises a plurality of operation section RF rails. The plurality of operation section RF rails is configured to, when an operation RF voltage is applied thereto, define a plurality of operation confinement regions configured for confining the quantum objects. Each operation section RF rail of the plurality of operation section RF rails has an operation thickness in a direction perpendicular to a longitudinal axis of the operation section RF rail. The operation thickness is larger than the sorting thickness.

In an example embodiment, the plurality of sorting section RF rails comprises a plurality of parallel pairs of sorting section RF rails that are separated by a sorting separation, the plurality of operation section RF rails comprises a plurality of parallel pairs of operation section RF rails that are separated by an operation separation, and the sorting separation is larger than the operation separation.

In an example embodiment, the sorting confinement regions are configured to confine the quantum objects with a quantum object-confinement apparatus surface distance of a sorting distance, the operation confinement regions are configured to confine the quantum objects with a quantum object-confinement apparatus surface distance of an operation distance, and the operation distance is larger than the sorting distance.

In an example embodiment, the confinement apparatus further comprises one or more transition zones, wherein each transition zone of the one or more transition zones is disposed between the operation section and a respective sorting section of the one or more sorting sections.

In an example embodiment, the transition zone comprises a plurality of transition RF rails and each transition RF rail of the plurality of transition RF rails has a thickness that changes over the length of the transition RF rail.

In an example embodiment, the transition RF rail has a thickness that is (a) substantially equal to the sorting thickness at an edge of the transition zone adjacent the respective sorting section and (b) substantially equal to the operation thickness at an edge of the transition zone adjacent the operation section.

In an example embodiment, the plurality of transition RF rails comprises a plurality of parallel pairs of transition RF rails that are separated by (a) a sorting separation at an edge of the transition zone adjacent the respective sorting section and (b) an operation separation at an edge of the transition zone adjacent the operation section.

In an example embodiment, the transition zone is configured to cause a quantum object-confinement apparatus surface distance of a quantum object confined by the confinement apparatus to change between (a) a sorting distance when the quantum object is at an edge of the transition zone adjacent the respective sorting section and (b) an operation distance when the quantum object is at an edge of the transition zone adjacent the operation section, wherein the change in the quantum object-confinement apparatus surface distance of the quantum object is adiabatic.

In an example embodiment, the sorting section further comprises a plurality of sorting control electrodes configured to be operated in accordance with a first noise tolerance and the operation section comprises a plurality of operation control electrodes configured to be operated in accordance with a second noise tolerance, the first noise tolerance being different from the second noise tolerance.

In an example embodiment, the sorting control electrodes comprise a plurality of broadcast control electrodes that are configured to receive respective broadcasted voltage signals.

In an example embodiment, a sorting control electrode of the plurality of sorting control electrodes has a sorting width, an operation control electrode of the plurality of operation control electrodes has an operation width, and the operation width is greater than the sorting width.

In an example embodiment, the sorting section is configured for performing sorting functions therein and the operation section is configured for performing quantum operation functions therein.

According to another aspect, a system is provided. In an example embodiment, the system comprises a plurality of voltage sources; operation filters; sorting filters; and a confinement apparatus. The confinement apparatus comprises one or more sorting sections, and an operation section. Each sorting section of the one or more sorting sections comprises a plurality of sorting section radio frequency (RF) rails. The plurality of sorting section RF rails is configured to, when a sorting RF voltage is applied thereto, define a plurality of sorting confinement regions configured for confining quantum objects. Each sorting section RF rail of the plurality of sorting section RF rails has a sorting thickness in a direction perpendicular to a longitudinal axis of the sorting section RF rail. The operation section comprises a plurality of operation section RF rails. The plurality of operation section RF rails is configured to, when an operation RF voltage is applied thereto, define a plurality of operation confinement regions configured for confining the quantum objects. Each operation section RF rail of the plurality of operation section RF rails has an operation thickness in a direction perpendicular to a longitudinal axis of the operation section RF rail. The operation thickness is larger than the sorting thickness. The plurality of voltage sources are configured to generate respective voltage sources that are filtered by a respective filter of the operation filters or the sorting filters, a voltage signal filtered by an operation filter is applied to the plurality of operation RF rails, and a voltage signal filtered by a sorting filter is applied to the plurality of sorting RF rails.

In an example embodiment, the sorting filters and the operation filters have different filter responses.

In an example embodiment, the sorting section is configured for performing sorting functions therein and the operation section is configured for performing quantum operation functions therein.

In an example embodiment, the system further comprising one or more manipulation sources and one or more beam path systems, wherein the operation section defines one or more quantum operation locations, and the one or more beam path systems are configured to provide manipulation signals generated by respective manipulation sources of the one or more manipulations sources to respective quantum operation locations.

In an example embodiment, the quantum operation locations include gating locations configured for performance of quantum logic operations on one or more quantum objects and measurement locations configured for performance of measurement operations on one or more quantum objects.

In an example embodiment, the plurality of sorting section RF rails comprises a plurality of parallel pairs of sorting section RF rails that are separated by a sorting separation, the plurality of operation section RF rails comprises a plurality of parallel pairs of operation section RF rails that are separated by an operation separation, and the sorting separation is larger than the operation separation.

In an example embodiment, the sorting confinement regions are configured to confine the quantum objects with a quantum object-confinement apparatus surface distance of a sorting distance, the operation confinement regions are configured to confine the quantum objects with a quantum object-confinement apparatus surface distance of an operation distance, and the operation distance is larger than the sorting distance.

In an example embodiment, the confinement apparatus further comprises one or more transition zones, wherein each transition zone of the one or more transition zones is disposed between the operation section and a respective sorting section of the one or more sorting sections.

In an example embodiment, the transition zone comprises a plurality of transition RF rails and each transition RF rail of the plurality of transition RF rails has a thickness that changes over the length of the transition RF rail.

In an example embodiment, the transition RF rail has a thickness that is (a) substantially equal to the sorting thickness at an edge of the transition zone adjacent the respective sorting section and (b) substantially equal to the operation thickness at an edge of the transition zone adjacent the operation section.

In an example embodiment, the plurality of transition RF rails comprises a plurality of parallel pairs of transition RF rails that are separated by (a) a sorting separation at an edge of the transition zone adjacent the respective sorting section and (b) an operation separation at an edge of the transition zone adjacent the operation section.

In an example embodiment, the transition zone is configured to cause a quantum object-confinement apparatus surface distance of a quantum object confined by the confinement apparatus to change between (a) a sorting distance when the quantum object is at an edge of the transition zone adjacent the respective sorting section and (b) an operation distance when the quantum object is at an edge of the transition zone adjacent the operation section, wherein the change in the quantum object-confinement apparatus surface distance of the quantum object is adiabatic.

In an example embodiment, the sorting section further comprises a plurality of sorting control electrodes configured to be operated in accordance with a first noise tolerance and the operation section comprises a plurality of operation control electrodes configured to be operated in accordance with a second noise tolerance, the first noise tolerance being different from the second noise tolerance.

In an example embodiment, the sorting control electrodes comprise a plurality of broadcast control electrodes that are configured to receive respective broadcasted voltage signals.

In an example embodiment, a sorting control electrode of the plurality of sorting control electrodes has a sorting width, an operation control electrode of the plurality of operation control electrodes has an operation width, and the operation width is greater than the sorting width.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example system comprising a quantum object confinement apparatus, in accordance with an example embodiment.

FIG. 2 provides a schematic top view of at least a portion of an example quantum object confinement apparatus, in accordance with an example embodiment.

FIG. 3 provides a schematic top view of at least a portion of another example quantum object confinement apparatus, in accordance with an example embodiment.

FIG. 4A provides a schematic illustration of a portion of a sorting section of a confinement apparatus, in accordance with an example embodiment.

FIG. 4B provides a schematic illustration of a portion of an operation section of a confinement apparatus, in accordance with an example embodiment.

FIGS. 5A, 5B, and 5C provide respective plots showing an example changes in geometry and operating parameters across different sections and zones of an example confinement apparatus, in accordance with an example embodiment.

FIG. 6 provides a schematic diagram of an example controller of a system comprising a quantum object confinement apparatus configured for confining quantum objects therein, in accordance with an example embodiment.

FIG. 7 provides a schematic diagram of an example computing entity of a system comprising a quantum object confinement apparatus that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, quantum objects are confined by a quantum object confinement apparatus (also referred to as a confinement apparatus herein). In various embodiments, a quantum object is an ion; atom; ionic, molecular, and/or multipolar molecule; quantum dot; quantum particle; group, crystal, and/or combination thereof (e.g., an ion crystal comprising two or more ions); and/or the like. In an example embodiment where the quantum objects are ions and/or ion crystals, the confinement apparatus is an ion trap, such as a surface ion trap, Paul ion trap, and/or the like. In various other embodiments, the confinement apparatus is an apparatus configured to confine quantum objects and comprises two or more sections that are configured for performance of a particular class of functions.

In an example embodiment, the confinement apparatus comprises one or more sorting and storing sections (also referred to herein as a sorting section) configured for performance of a class of functions referred to herein as sorting and storing functions (also referred to herein as sorting functions). In various embodiments, sorting and/or storing functions include sorting quantum objects. For example, quantum objects may be sorted to change the order or positioning of quantum objects in a string/one-dimensional array, two-dimensional array, or three-dimensional array of quantum objects. In various embodiments, sorting and/or storing functions include maintaining a quantum object at a location in a manner such that the quantum information stored by the quantum object is maintained and/or not likely to be disrupted. For example, the quantum object may be stored such that it is unlikely that an external field used to perform a quantum operation function on other quantum objects will affect the quantum information encoded by the quantum state of the quantum object.

The example confinement apparatus further comprises a quantum operation section (also referred to herein as an operation section) configured for performance of a class of functions referred to herein as operation functions. In various embodiments, a function of the class of operation functions is a function that includes interacting one or more quantum objects with one another and/or an external field (e.g., magnetic field, magnetic field gradient, laser beam(s)/pulse(s), microwave(s)). For example, quantum logic gates (e.g., single qubit gates, two-qubit gates) and reading and/or measurement operations are examples of functions of the class of operation functions.

In various embodiments, sections configured for performance of different classes of functions have different geometries and/or operating parameters. For example, in various embodiments where the confinement apparatus comprises radio frequency (RF) rails and control electrodes, the thickness of the RF rails in a sorting section may be smaller than the thickness of the RF rails in an operation section, the separation between pairs of RF rails in a sorting section may be larger than the separation between pairs of RF rails in an operation section, and/or the like. For example, in various embodiments, the potential generating elements (e.g., RF rails, control electrodes, and/or the like) of a sorting section of the confinement apparatus may be configured to generate confinement regions at a first height or distance from a surface of the confinement apparatus and the potential generating elements (e.g., RF rails, control electrodes, and/or the like) of an operation section of the confinement apparatus may be configured to generate confinement regions at a second height or distance from a surface of the confinement apparatus, where the second height or distance is greater/larger than the first height or distance. In various embodiments, the noise tolerance for voltage signals applied to the potential generating elements (e.g., RF rails, control electrodes, and/or the like) of a sorting section of the confinement apparatus may be different from the noise tolerance for voltage signals applied to the potential generating elements (e.g., RF rails, control electrodes, and/or the like) of an operation section of the confinement apparatus.

In various embodiments, the confinement apparatus further comprises one or more transition zones. For example, the transition zones are portions of the confinement apparatus where the geometry and/or operating parameters of the confinement apparatus transition or change from the geometry and/or operating parameters of a first section of the confinement apparatus to the geometry and/or operating parameters of a second section of the confinement apparatus. For example, a transition zone may be disposed between a sorting section and an operation section. The geometry and/or operating parameters of the transition zone change across the transition zone from a geometry and/or operating parameters matching those of the sorting section to a geometry and/or operating parameters matching those of the operation section. For example, in an example embodiment the thickness of the RF rails in a sorting section is smaller or less than the thickness of the RF rails in an operation section and the thickness of the RF rails in the transition zone transitions from the thickness of the RF rails in the sorting section (at an edge of the transition zone adjacent and/or proximate to the sorting section) to the thickness of the RF rails in the operation zone (at an edge of the transition zone adjacent and/or proximate to the operation section).

In various embodiments, the geometry and/or operating parameter transition that occurs within a transition zone is configured such that when a quantum object traverses a transition zone (e.g., from a sorting section to an operation section or from an operation section to a sorting section), the quantum information stored by the quantum object is maintained, not disturbed, and/or not perturbed. For example, the quantum object traversing the transition zone experiences the geometry and/or operating parameter transition adiabatically. As should be understood by one of skill in the art, a quantum object's traversal of a transition zone is smooth and/or a quantum object experiences the geometry and/or operating parameter transition smoothly when the transition of the geometry and/or operation parameter occurs slowly enough to prevent the quantum object from experiencing a discontinuity in the geometry and/or operation parameter and/or in a first derivative of the geometry and/or operation parameter.

In various embodiments, the quantum objects confined by a confinement apparatus are used to perform experiments, controlled quantum state evolution, quantum computations, and/or the like. In various embodiments, the quantum objects are transported between various locations at least partially defined by the confinement apparatus and/or a system comprising the confinement apparatus. For example, a quantum object may be transported from a storing location within a sorting section into a quantum operation location defined within an operation section of the confinement apparatus. One or more quantum operations may be performed on the quantum object while it is disposed within the operation section and then the quantum object may be transported back to the sorting section for storage and/or future sorting.

Conventional ion traps (e.g., surface ion traps) are configured for performing both sorting and operation functions in a common area. For example, a sorting function and a logical quantum operation may be performed at the same location of the ion trap. The drawback of this approach is that sorting functions and operation functions typically have very different sets of design requirements. For example, for sections of an ion trap where sorting functions are performed it may be desired to minimize the distance between junctions to minimize the distance the ions need to be transported to perform sorting functions. However, such ion trap geometry requires or implies the ions should be confined close to the surface of the ion trap. Fast sorting and transport functions also call for large bandwidth voltage sources, placing restrictions on how much filtering can be used to mitigate resonant noise effects. Additionally, sorting functions are sensitive to different noise sources, such as electric fields and voltage noise, compared to operation functions and have unique ion crystal temperature requirements.

Areas where operation functions are performed, benefit from larger distances between the ions and ion trap surface to (1) reduce heating effects detrimental to operation functions, (2) reduce laser scatter from the surface of the ion trap that can degrade the fidelity of reading and/or measurement operations. Areas where operation functions are performed typically require several individually controlled electrodes to compensate for imperfections in trapping potentials (alternatively, quantum operations can be serialized). Since minimal unit cell geometries typically assume on the order of one qubit per junction, including quantum operation compensation electrodes in each unit cell can result in large electrode and signal overheads. The aforementioned restrictions on ion-to-trap surface distance in areas where operation functions are performed also tend to result in larger RF electrode areas and, therefore, capacitances which in-turn results in larger RF power dissipation which can present other technical difficulties. Also, the minimal unit cell geometry implies that decreasing the distance between junctions to increase sorting speeds simultaneously decreases the distance between quantum operation zones which can increase technical difficulties associated with crosstalk of quantum control fields such as finite laser beam widths, laser scatter from fluorescing ions or the trap surface, or microwave fields.

Therefore, technical problems exist with convention ion traps where sorting class functions and quantum operation class functions are performed in common areas of the ion trap.

Various embodiments provide technical solutions to these technical problems. By separating a quantum object confinement apparatus into sections configured for performing sorting and storing class functions and sections configured for performing quantum operation functions, it is possible to gain several technical advantages, many of which are the converses of the disadvantages of the minimal unit cell geometry. For example, when quantum operation locations are not included in sorting sections, any relevant distance scales in the sorting section may be decreased because there is not contraindication for using smaller quantum object-confinement apparatus surface distances and not as many electrodes are needed to sufficiently control the potential wells. Since sorting functions typically do not require the same amount of control over potential wells as quantum operations do, the confinement apparatus could in principle operate with a smaller number of independent signals and electrodes, assuming that quantum operation locations can be shared in a serialized manner.

By using a smaller quantum object-confinement apparatus surface distance in the sorting section, quantum objects can be stored with a higher density which can lead to faster sorting times and smaller RF electrode footprints which results in a smaller amount of RF power being dissipated. When operation functions are not performed within in the sorting section, larger bandwidth electronics (or looser filtering requirements) can be used to help achieve fast transport speeds with minimal electronic drive complexity. The higher density sorting region can also lead to an overall smaller geometry, possibly alleviating laser scattering issues. By separating the quantum operation locations into an operation section of the confinement apparatus that is physically separated and/or distinct from the sorting section, a larger quantum object-confinement apparatus surface distance can be used in the operation section. The larger quantum object-confinement apparatus surface distance (compared to in the sorting section) can mitigate quantum object heating issues during gating operations and mitigate laser scattering during reading and/or measurement operations. Additionally, the distance between quantum operation locations can be optimized for crosstalk issues without a necessarily proportional increase in the distance scale of the sorting section. If the separated quantum operation locations are used serially, the qubit to quantum operation location ratio can be much larger than one, thereby decreasing the number of electrodes and signals needed to operate all of the quantum operation locations. Thus, various embodiments provide technical improvements to the technical fields of trapped atomic systems and quantum charge-coupled device (QCCD)-based quantum computing.

### Exemplary System Comprising a Quantum Object Confinement Apparatus

Various embodiments provide (quantum object) confinement apparatuses that includes sorting sections and operations sections that are physically separated and/or distinct from one another. Such confinement apparatuses may be incorporated into a variety of trapped atomic systems, QCCD-based quantum computing systems, and/or the like. An example QCCD-based quantum computing system will now be disclosed.

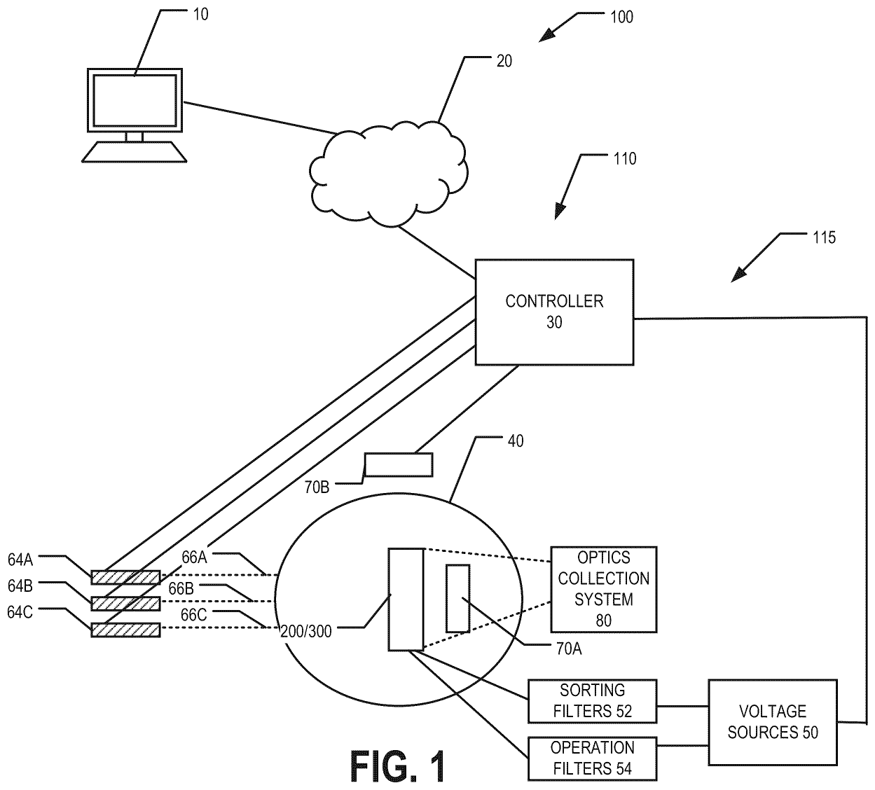

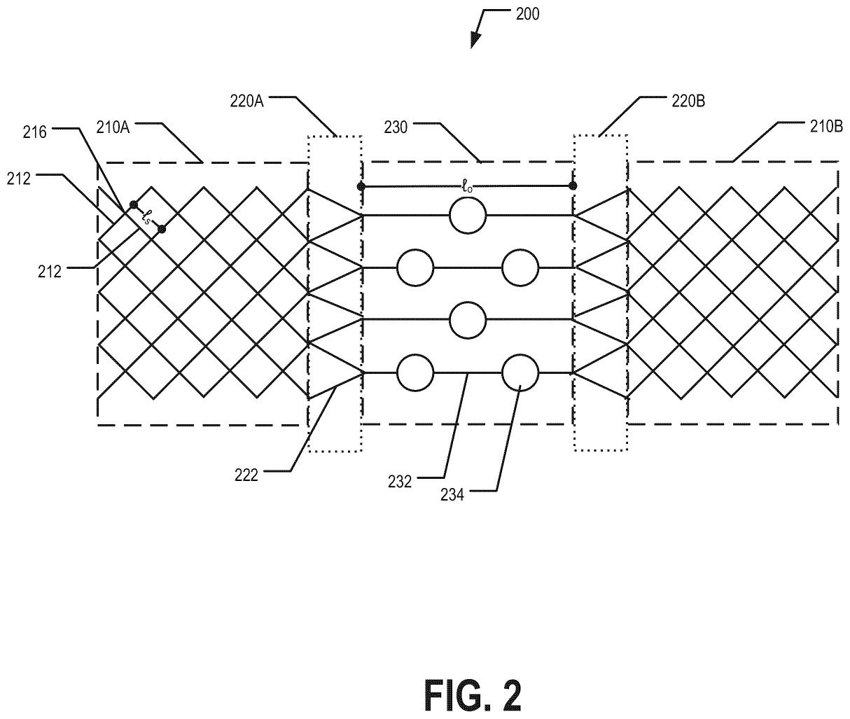

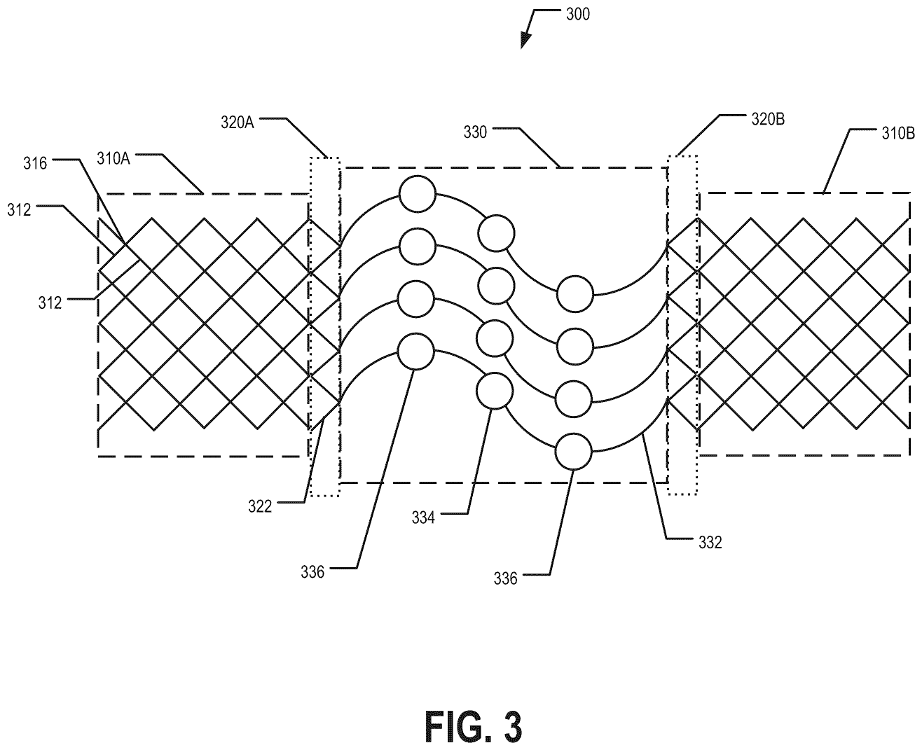

Various embodiments provide a system 100 comprising a quantum object confinement apparatus 200/300 (see FIGS. 2 and 3), as shown in FIG. 1. The quantum object confinement apparatus 200/300 is configured to confine a plurality of quantum objects such that the respective quantum states of the quantum objects may be manipulated, evolved in a controlled manner (e.g., in accordance with a quantum circuit), and/or the like.

For example, quantum operation functions (one qubit quantum logic gates, two qubit quantum logic gates, initialization, reading and/or measurement operations, and/or the like) may be performed on quantum objects disposed within quantum operation locations defined by the confinement apparatus 200/300 and/or system 100 comprising the confinement apparatus. For example, the confinement apparatus 200/300 is configured to maintain one or more quantum objects at a quantum operation location such that the quantum operation may be performed one the one or more quantum objects. In various embodiments, the system 100 comprising the confinement apparatus 200/300 comprises one or more manipulation sources 64 (e.g., 64A, 64B, 64C) configured to provide manipulation signals (e.g., laser beams and/or pulses, microwave signals, and/or the like) such that the manipulation signals interact with one or more quantum objects disposed at the quantum operation location. In various embodiments, the system 100 comprising the confinement apparatus 200/300 comprises one or more magnetic field sources 70 (e.g., 70A, 70B) configured to provide a controlled magnetic field and/or magnetic field gradient at quantum operation locations for use in performing one or more quantum operations on one or more quantum objects disposed at the quantum operation location. In various embodiments, the system 100 comprising the confinement apparatus 200/300 comprises an optics collection system 80 configured to collect and/or detect light and/or photons emitted by one or more quantum objects disposed at the quantum operation location.

In an example embodiment, the system 100 comprising the confinement apparatus 200/300 is and/or includes a quantum charge-coupled device (QCCD)-based quantum computer. For example, one or more of the quantum objects confined by the confinement apparatus 200/300 may be used as qubits of the quantum computer.

In various embodiments, the system 100 comprises a computing entity 10 and a quantum computer 110. In various embodiments, the quantum computer 110 comprises a controller 30 and a quantum processor 115. In various embodiment, the quantum processor 115 comprises a cryostat and/or vacuum chamber 40 enclosing a confinement apparatus 200/300, one or more manipulation sources 64 (e.g., 64A, 64B, 64C), one or more voltage sources 50, one or more magnetic field sources 70 (e.g., 70A, 70B), an optics collection system 80, and/or the like. In various embodiments, the controller 30 is configured to control the operation of (e.g., control one or more drivers configured to cause operation of) the manipulation sources 64, voltage sources 50, magnetic field sources 70, a vacuum system and/or cryogenic cooling system (not shown), and/or the like. In various embodiments, the controller 30 is configured to receive signals (e.g., electrical signals) generated and provided by the optics collection system 80.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more quantum objects within the confinement apparatus 200/300. For example, a first manipulation source 64A is configured to generate and/or provide a first manipulation signal and a second manipulation source 64B is configured to generate and/or provide a second manipulation signal, where the first and second manipulation signals are configured to perform one or more quantum operations (single qubit gates, two-qubit gates, cooling, initialization, reading/measurement, and/or like) on quantum objects confined by the confinement apparatus 200/300.

In an example embodiment, the one or more manipulation sources 64 each provide a manipulation signal (e.g., laser beam and/or the like) to one or more portions (e.g., quantum operation locations) of the atomic object confinement apparatus 200/300 via corresponding beam path systems 66 (e.g., 66A, 66B, 66C). In various embodiments, at least one beam path system 66 comprises a modulator configured to modulate the manipulation signal being provided to the confinement apparatus 200/300 via the beam path system 66. In various embodiments, the manipulation sources 64, active components of the beam path systems 66 (e.g., modulators and/or the like), and/or other components of the quantum computer 110 are controlled by the controller 30.

In various embodiments, the confinement apparatus 200/300 is an ion trap, such as a surface ion trap, Paul ion trap, and/or the like. In various embodiments, the quantum objects are ions; atoms; ion crystals and/or groups; atomic crystals and/or groups; ionic, molecular, and/or multipolar molecules; quantum dots; quantum particles; groups, crystals, and/or combinations thereof (e.g., ion crystals); and/or the like. In various embodiments, the confinement apparatus 200/300 is an appropriate confinement apparatus for confining the quantum objects of the embodiment.

In various embodiments, the quantum computer 110 comprises one or more voltage sources 50. For example, the voltage sources may be arbitrary wave generators (AWG), digital-analog converts (DACs), and/or other voltage signal generators. For example, the voltage sources 50 may comprise a plurality of control voltage drivers and/or voltage sources and/or at least one RF driver and/or voltage source. The voltage sources 50 may be electrically coupled to the corresponding potential generating elements (e.g., control electrodes and/or RF electrodes) of the confinement apparatus 200/300, in an example embodiment. In various embodiments, the voltage sources 50 include sorting voltage sources that are electrically coupled to the potential generating elements (e.g., control electrodes and/or RF electrodes) of the sorting section of the confinement apparatus 200/300 and operation voltage sources that are electrically coupled to the potential generating elements (e.g., control electrodes and/or RF electrodes) of the operation section of the confinement apparatus 200/300.

In various embodiments, the voltage signals generated by the voltage sources 50 are filtered before being applied to the potential generating elements (e.g., control electrodes and/or RF electrodes) of the sorting section of the confinement apparatus 200/300. In an example embodiment, the system 100 comprises sorting filters 52 and operation filters 54. The sorting filters 52 are configured to filter the voltage signals applied to the potential generating elements (e.g., control electrodes and/or RF electrodes) of the sorting section of the confinement apparatus 200/300. The operation filters 54 are configured to filter voltage signals applied to the potential generating elements (e.g., control electrodes and/or RF electrodes) of the operation section of the confinement apparatus 200/300. In various embodiments, the sorting filters 52 and the operation filters 54 have different filter responses, different cut-off frequencies, and/or the like.

In various embodiments, the quantum computer 110 comprises one or more magnetic field sources 70 (e.g., 70A, 70B). For example, the magnetic field source may be an internal magnetic field source 70A disposed within the cryogenic and/or vacuum chamber 40 and/or an external magnetic field source 70B disposed outside of the cryogenic and/or vacuum chamber 40. In various embodiments, the magnetic field sources 70 comprise permanent magnets, Helmholtz coils, electrical magnets, and/or the like. In various embodiments, the magnetic field sources 70 are configured to generate a magnetic field and/or magnetic field gradient at one or more locations defined by the confinement apparatus 200/300 that has a particular magnitude and a particular magnetic field direction in the one or more locations defined by the confinement apparatus 200/300.

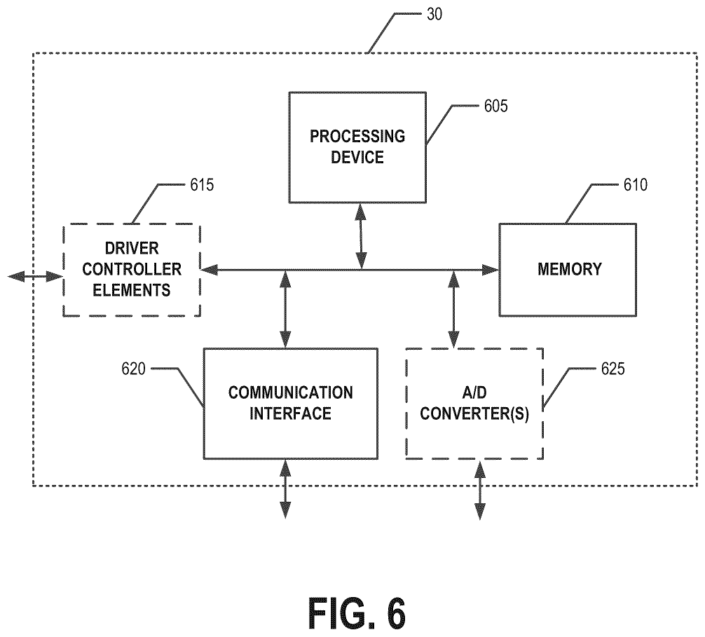

In various embodiments, the quantum computer 110 comprises an optics collection system 80 configured to collect and/or detect photons (e.g., stimulated emission) generated by quantum objects disposed in respective quantum operation locations (e.g., during reading/measurement operations). The optics collection system 80 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the quantum objects. In various embodiments, the detectors may be in electronic communication with the controller 30 via one or more A/D converters 625 (see FIG. 6) and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control the voltage sources 50, magnetic field sources 70, cryogenic system and/or vacuum system controlling the temperature and/or pressure within the cryogenic and/or vacuum chamber 40, manipulation sources 64, and/or other systems controlling various environmental conditions (e.g., temperature, pressure, and/or the like) within the cryogenic and/or vacuum chamber 40, configured to manipulate and/or cause a controlled evolution of quantum states of one or more quantum objects within the confinement apparatus 200/300, and/or read and/or measure a quantum (e.g., qubit) state of one or more quantum objects within the confinement apparatus. For example, the controller 30 may cause a controlled evolution of quantum states of one or more quantum objects confined by the confinement apparatus 200/300 to execute a quantum circuit and/or algorithm. For example, the controller 30 may read and/or detect quantum states of one or more quantum objects within the confinement apparatus 200/300 at one or more points during the execution of a quantum circuit. In various embodiments, the quantum objects confined by the confinement apparatus are used as qubits of the quantum computer 110.

### Exemplary Atomic Object Confinement Apparatus

FIG. 2 provides a top view of at least a portion of an example confinement apparatus 200 that may be used to confine one or more quantum objects. For example, in the illustrated embodiment, the confinement apparatus is an ion trap (e.g., a surface ion trap) and the quantum objects are ions and/or ion crystals. In an example embodiment, the confinement apparatus 200 (e.g., surface ion trap) is fabricated as part of an ion trap chip and/or part of an ion trap apparatus and/or package.

The confinement apparatus 200 includes sorting sections 210 (e.g., 210A, 210B) and an operation section 230. In the illustrated embodiment, the operation section 230 is disposed between two sorting sections 210. In various other embodiments, an operation section 230 may be disposed between three or four sorting sections 210. In various embodiments, multiple operation sections 230 may be disposed between pairs of sorting sections 210, and/or the like. In particular, in various embodiments, the confinement apparatus 200 comprises one or more sorting sections 210 and one or more operation sections 230.

The sorting section 210 comprises a plurality of sorting confinement regions 212 that are connected to neighboring sorting confinement regions 212 by respective junctions 216. For example, in the illustrated embodiment, the sorting confinement regions 212 of the sorting section 210 form a grid or two-dimensional array of confinement regions. In various embodiments, the length scale of the sorting section, illustrated in FIG. 2 by the junction-to-junction distance [symbol] ₛ is shorter than the length scale of the operation section (e.g., the junction-to-junction distance [symbol] ₒ).

The operation section 230 comprises a plurality of operation confinement regions 232 having one or more quantum operation locations 234 defined there along. In various embodiments, each of the operation confinement regions 232 have the same number and spatial distribution of quantum operation locations 234. In various embodiments, different operation confinement regions 232 may have different numbers and/or spatial distributions of quantum operation locations 234. In an example embodiment, various quantum operation locations 234 may be aligned such that a beam path (e.g., for a beam provided via a beam path system 66) may be incident on a plurality of quantum operation locations 234.

In various embodiments, the confinement apparatus 200 comprises one or more transition zones 220 (e.g., 220A, 220B). In various embodiments, a transition zone 220 is disposed between a sorting section 210 and the operation section 230. The transition zones 220 each comprise a plurality of transition confinement regions 222. The transition confinement regions 222 each connect one or more sorting confinement regions 212 to one or more operation confinement regions 232. For example, quantum objects are transported from the sorting section 210 to the operation section 230 (or vice versa) along the transition confinement regions 222 of the transition zone 220.

FIG. 3 illustrates another example confinement apparatus 300. The confinement apparatus 300 includes sorting sections 310 (e.g., 310A, 310B) and an operation section 330. In the illustrated embodiment, the operation section 330 is disposed between two sorting sections 310. In particular, in various embodiments, the confinement apparatus 300 comprises one or more sorting sections 310 and one or more operation sections 330.

The sorting section 310 comprises a plurality of sorting confinement regions 312 that are connected to neighboring sorting confinement regions 312 by respective junctions 316. For example, in the illustrated embodiment, the sorting confinement regions 312 of the sorting section 310 form a grid or two-dimensional array of confinement regions.

The operation section 330 comprises a plurality of operation confinement regions 332 having one or more quantum operation locations defined there along. In the illustrated embodiment, the quantum operation locations include reading and/or measurement locations 336 and gating locations 334. For example, the gating location 334 is disposed between two reading and/or measurement locations 336. For example, the gating locations 334 are configured to have quantum logic operations (e.g., single qubit gates, two-qubit gates, and/or the like) performed thereat. The reading and/or measurement locations 336 are configured for performing reading and/or measurement operations.

The operation confinement regions 332 of the confinement apparatus 300 are curved. For example, the operation confinement regions 332 of the embodiment illustrated in FIG. 3 have the geometry of a single period of a sine function or wave. In various embodiments, the operation confinement regions 332 may have various geometries, as appropriate for the application.

In various embodiments, the confinement apparatus 300 comprises one or more transition zones 320 (e.g., 320A, 320B). In various embodiments, a transition zone 320 is disposed between a sorting section 310 and the operation section 230. The transition zones 320 each comprise a plurality of transition confinement regions 322. The transition confinement regions 322 each connect one or more sorting confinement regions 312 to one or more operation confinement regions 332. For example, quantum objects are transported from the sorting section 310 to the operation section 330 (or vice versa) along the transition confinement regions 322 of the transition zone 320.

In various embodiments, the geometry and/or operating parameters of the sorting sections 210, 310 are different from the geometry and/or operating parameters of the operation section 230, 330. In various embodiments, the geometry and/or operating parameters of the transition zone 220, 320 transition or change across the width of the transition zone, such that as a quantum object is transported from the sorting section 210, 310 to the operation section 230, 330 through the transition zone 220, 320, the quantum object experiences slow, adiabatic changes in the environment of the quantum object. For example, the quantum object-confinement apparatus surface distance (e.g., the distance between the quantum object and the confinement apparatus surface) in the sorting section 210, 310 is less than the quantum object-confinement apparatus surface distance in the operation section 230, 330. Thus, as the quantum object traverses the transition zone, the quantum object-confinement apparatus surface distance changes slowly and adiabatically.

In the illustrated embodiments, the operation section 330 is disposed between two sorting sections 310. In another example embodiment, the sorting section 310 is disposed between a plurality of operation sections 330. For example, one or more operation sections 330 may be disposed around a central sorting section 310.

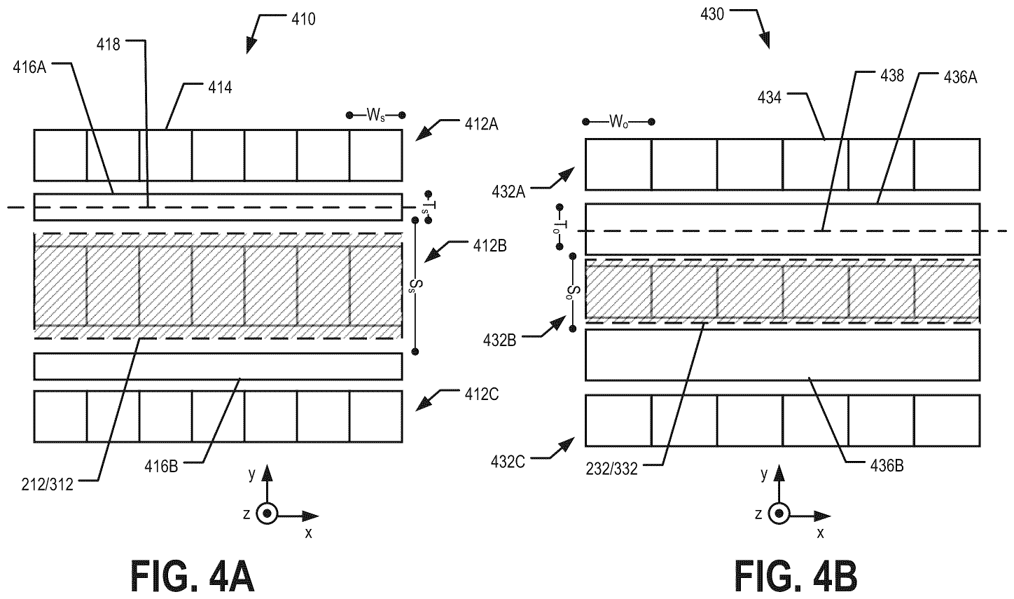

FIG. 4A illustrates a portion of a sorting section leg 410 that, when appropriate voltage signals are applied to the potential generating elements (e.g., control electrodes 414 and RF rails 416 (e.g., 416A, 416B)) generates and/or defines a sorting confinement region 212/312. In an example embodiment, the sorting section leg 410 is at least partially defined by a number of RF electrodes or RF rails 416 (e.g., 416A, 416B). In various embodiments, the sorting section leg 410 is at least partially defined by a number of sequences of control electrodes 412 (e.g., 412A, 412B, 412C). Each sequence of control electrodes 412 comprises a plurality of control electrodes 414. In an example embodiment, at least some of the control electrodes 414 are operated via application of a broadcast control signal, as described, for example, in U.S. Application No. 63/379,040, filed Oct. 11, 2022, the content of which is hereby incorporated by reference in its entirety.

In various embodiments, a pair of RF rails 416 are substantially parallel, such that the longitudinal axis 418 of the two RF rails 416 of the pair of RF rails are parallel to one another. The two RF rails 416 of the pair of RF rails are separated from one another by a sorting separation Sₛ. The thickness of an RF rail 416 in a direction perpendicular to the longitudinal axis 418 of the RF rail 416 is a sorting thickness Tₛ. In various embodiments, the sequences of control electrodes 412 extend substantially parallel to the longitudinal axis 418 of the RF rails 416. In an example embodiment, the width of a control electrode 414 in a direction substantially parallel to the longitudinal axis 418 of the RF rail is a sorting width Wₛ.

FIG. 4B illustrates a portion of an operation section leg 430 that, when appropriate voltage signals are applied to the potential generating elements (e.g., control electrodes 434 and RF rails 436 (e.g., 436A, 436B)) generates and/or defines an operation confinement region 232/332. In an example embodiment, the operation section leg 430 is at least partially defined by a number of RF electrodes or RF rails 436 (e.g., 436A, 436B). In various embodiments, the operation section leg 430 is at least partially defined by a number of sequences of control electrodes 432 (e.g., 432A, 432B, 432C). Each sequence of control electrodes 432 comprises a plurality of control electrodes 434. In various embodiments, the control electrodes 434 may be controlled independently (e.g., have independent voltage signals applied thereto). In various embodiments, two or more of the control electrodes 434 may be configured to receive a broadcasted voltage signal.

In various embodiments, a pair of RF rails 436 are substantially parallel, such that the longitudinal axis 438 of the two RF rails 436 of the pair of RF rails are parallel to one another. The two RF rails 436 of the pair of RF rails are separated from one another by an operation separation Sₒ. The thickness of an RF rail 436 in a direction perpendicular to the longitudinal axis 438 of the RF rail 436 is an operation thickness Tₒ. In various embodiments, the sequences of control electrodes 432 extend substantially parallel to the longitudinal axis 438 of the RF rails 436. In an example embodiment, the width of a control electrode 434 in a direction substantially parallel to the longitudinal axis 438 of the RF rail is operation width Wₒ.

In an example embodiment, the confinement apparatus comprising the sorting section leg 410 and the operation section leg 430 is a surface Paul trap with symmetric RF rails 416, 436. In various embodiments, the RF rails 416, 436 and the control electrodes 414, 434 generate potentials and/or fields that are experienced by quantum objects within the respective confinement region 212, 312, 232, 332 of the confinement apparatus 200, 300. In particular, the RF rails 416, 436 may be configured to define the respective confinement region 212, 312, 232, 332 and the control electrodes 414, 434 may be configured to at least partially control movement and/or motion of quantum objects along the respective confinement regions.

As noted above, in various embodiments, the geometry and/or operating parameters of the sorting section(s) 210, 310 are different from the geometry and/or operating parameters of the operation section(s) 230, 330. FIGS. 4A and 4B illustrate at least some of the geometry differences between a sorting section leg 410 and an operation section leg 430. For example, the sorting width Wₛ is smaller than the operation width Wₒ (Wₛ<Wₒ), in various embodiments. In another example, the sorting separation Sₛ is larger than the operation separation Sₒ (Sₛ>Sₒ), in various embodiments. In another example, the sorting thickness Tₛ is greater than the operation thickness Tₒ (Tₛ>Tₒ), in various embodiments.

For example, the sorting filters 52 used to filter the voltage signals applied to the potential generating elements of the sorting section leg 410 (e.g., RF rails 416, control electrodes 414) may have different filter responses than the operation filters 54 used to filter voltage signals applied to the potential generating elements of the operation section leg 430 (e.g., RF rails 436, control electrodes 434). For example, the operation filters 54 may be configured to filer voltage signals to provide filtered voltage signals with less noise in one or more frequency bands than the sorting filters 52. In another example, due at least in part to the differences in the RF rail thickness and separation in the sorting sections compared to the operation sections, a quantum object disposed in a sorting section has a smaller quantum object-confinement apparatus surface distance than a quantum object disposed in an operation section.

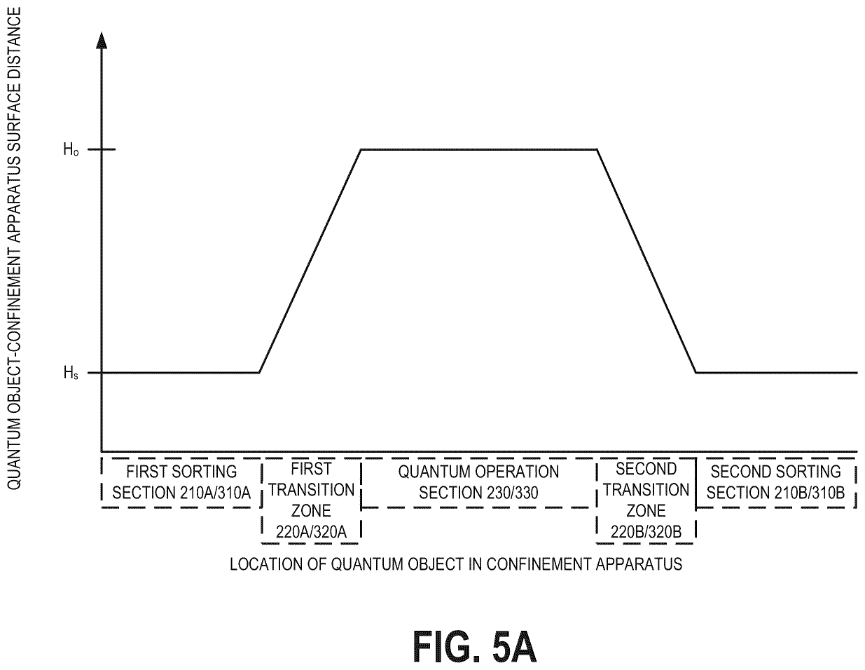

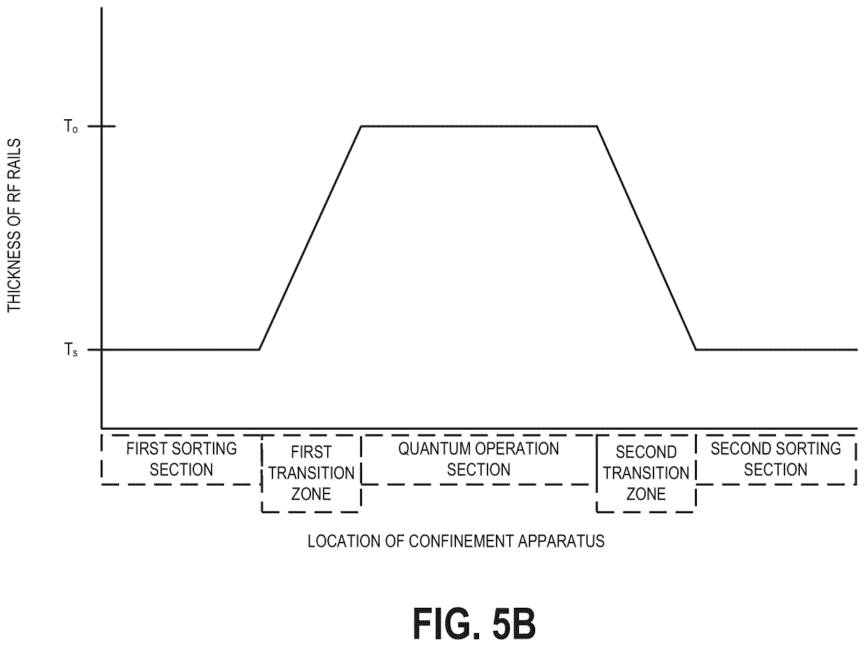

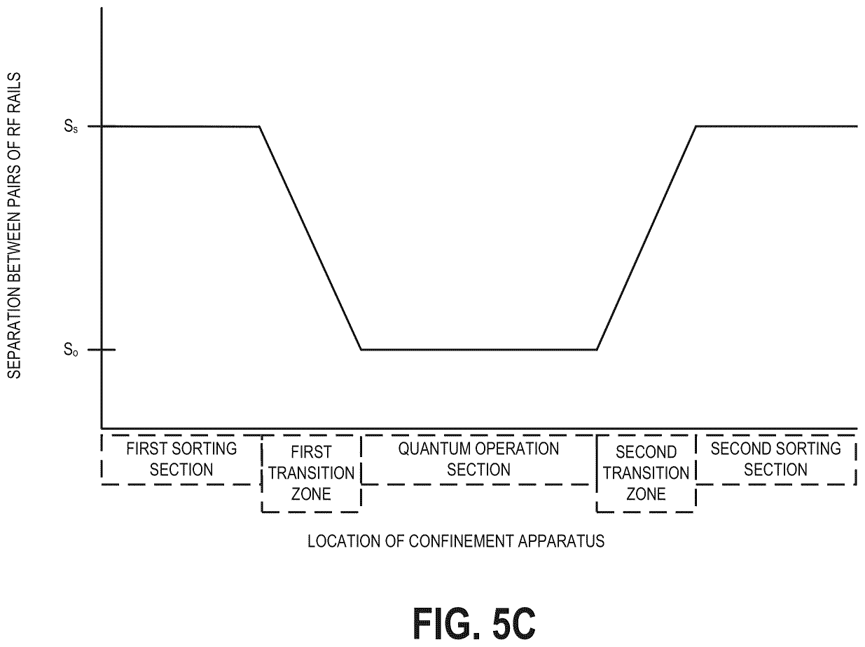

For example, FIG. 5A illustrates the quantum object-confinement apparatus surface distance of a quantum object based on where the quantum object is located in the confinement apparatus 200/300. As used herein, the quantum object-confinement apparatus surface distance is the distance between the quantum object and the surface of the confinement apparatus. For example, the quantum object-confinement apparatus surface distance is a distance in the z-direction as illustrated in FIGS. 4A and 4B, which show the confinement apparatus surface in the xy plane.

As shown in FIG. 5A, when a quantum object is disposed in the first sorting section 210A or the second sorting section 210B, the quantum object-confinement apparatus surface distance is a sorting distance Hₛ and when the quantum object is disposed in the operation section 230, the quantum object-confinement apparatus surface distance is an operation distance Hₒ. The operation distance is greater than the sorting distance (Hₛ<Hₒ). In an example embodiment, the sorting distance Hₛ is in a range of 20-100 μm. In an example embodiment, the sorting distance Hₛ is in a range of 20-50 μm. In various embodiments, the sorting distance Hₛ is smaller than 20 μm. In an example embodiment, the operation distance Hₒ is in a range of 20-100 μm. In an example embodiment, the operation distance Hₒ is in a range 30-100 μm. For example, in an example embodiment, the operation distance Hₒ is in a range of 30-60 μm.

When a quantum object enters the first transition zone 220A from the first sorting section 210A, the quantum object-confinement apparatus surface distance is the sorting distance Hₛ. The quantum object-confinement apparatus surface distance of the quantum object monotonically changes as the quantum object traverses the transition zone 220A heading toward the operation section 230. For example, the quantum object-confinement apparatus surface distance of the quantum object changes as the quantum object traverses the transition zone 220A adiabatically such that the quantum information stored by the quantum object is not disturbed or perturbed as the quantum object traverses the transition zone. When the quantum object reaches the edge of the transition zone 220A neighboring and/or adjacent to the operation zone, the quantum object-confinement apparatus surface distance is an operation distance Hₒ.

In various embodiments, the sorting width Wₛ is in a range of half the sorting distance Hₛ and 1.2 times the sorting distance Hₛ (e.g., Hₛ/2<Wₛ<1.2*Hₛ). In various embodiments, the operation width Wₒ is in a range of half the operation distance Hₒ and 1.2 times the operation distance Hₒ (e.g., Hₒ/2<Wₒ<1.2*Hₒ). As the sorting distance Hₛ is less than the operation distance Hₒ, the sorting width Wₛ is less than the operation width Wₒ.

FIG. 5B illustrates an example of how the geometry of the sorting sections 210, 310 are different from the geometry of the operation section 230, 330. For example, the RF rails 416 of the sorting sections 210, 310 have a sorting thickness Tₛ that is smaller than the operation thickness Tₒ of the RF rails 436 in the operation section 230, 330. The thickness of the RF rails in the transition zones 220, 320 changes gradually across the respective transition zones. In various embodiments, the sorting thickness Tₛ and the operation thickness Tₒ of the RF rails is equal to or less than 200 μm. In an example embodiment, the sorting thickness Tₛ is equal to or less than 150 μm. For example, in an example embodiment, the sorting thickness Tₛ is in a range of 150-22 μm. In an example embodiment, the sorting thickness Tₛ is in a range of 100-22 μm. In an example embodiment, the operation thickness Tₒ is in a range of 200-50 μm. For example, in an example embodiment, the operation thickness Tₒ is in a range of 200-100 μm.

FIG. 5B illustrates an example of how the geometry of the sorting sections 210, 310 are different from the geometry of the operation section 230, 330. For example, the RF rails 416 of the sorting sections 210, 310 have a sorting thickness Tₛ that is smaller than the operation thickness To of the RF rails 436 in the operation section 230, 330. The RF rail thickness of the RF rails in the transition zone changes from the sorting thickness Tₛ at the edge of the transition zone 220, 320 that is neighboring and/or adjacent the sorting section to the operation thickness Tₒ at the edge of the transition zone 220, 320 that is neighboring and/or adjacent the operation section. The thickness of the RF rails in the transition zones 220, 320 changes gradually across the respective transition zones.

FIG. 5C illustrates another example of how the geometry of the sorting sections 210, 310 are different from the geometry of the operation section 230, 330. For example, the separation between parallel pairs of RF rails 416 of the sorting sections 210, 310 is a sorting separation Sₛ and the separation between parallel pairs of RF rails 436 of the operation section leg 430 is an operation separation Sₒ. The sorting separation Sₛ is larger than the operation separation Sₒ and the separation between parallel pairs of RF rails in the transition zone change from the sorting separation Sₛ at the edge of the transition zone 220, 320 that is neighboring and/or adjacent the sorting section to the operation separation Sₒ at the edge of the transition zone 220, 320 that is neighboring and/or adjacent the operation section. The separation of the parallel pairs of the RF rails in the transition zones 220, 320 changes gradually across the respective transition zones. In various embodiments, the operation separation Sₒ and the sorting separation Sₛ are in a range of 16-200 μm. For example, in an example embodiment, the operation separation Sₒ is in a range of 16-120 μm. For example, in an example embodiment, the operation separation Sₒ is in a range of 16-100 μm. For example, in an example embodiment, the sorting separation Sₛ is in a range of 50-200 μm. For example, in an example embodiment, the operation separation Sₒ is in a range of 100-200 um.

A quantum object traversing a transition zone 220, 320 (e.g., along a respective transition confinement region 222, 322) from a sorting section 210, 310 to an operation section 230, 330 experiences the RF rails getting thicker and closer together as the quantum object approaches the operation section 230, 330. This causes the quantum object-confinement apparatus surface distance to increase as the quantum object traverses the transition zone 220, 320 (e.g., along a respective transition confinement region 222, 322) toward the operation section 230, 330. The RF rail separation and RF rail thickness changes gradually and/or smoothly such that the height of the quantum object changes adiabatically.

### Technical Advantages

Conventional ion traps (e.g., surface ion traps) are configured for performing both sorting and operation functions in a common area. For example, a sorting function and a logical quantum operation may be performed at the same location of the ion trap. The drawback of this approach is that sorting functions and operation functions typically have very different sets of design requirements. For example, for sections of an ion trap where sorting functions are performed it may be desired to minimize the distance between junctions to minimize the distance the ions need to be transported to perform sorting functions. However, such ion trap geometry requires or implies the ions should be confined close to the surface of the ion trap. Fast sorting and transport functions also call for large bandwidth voltage sources, placing restrictions on how much filtering can be used to mitigate resonant noise effects. Additionally, sorting functions are sensitive to different noise sources, such as electric fields and voltage noise, compared to operation functions and have unique ion crystal temperature requirements.

Areas where operation functions are performed, benefit from larger distances between the ions and ion trap surface to (1) reduce heating effects detrimental to operation functions, (2) reduce laser scatter from the surface of the ion trap that can degrade the fidelity of reading and/or measurement operations. Areas where operation functions are performed typically require several individually controlled electrodes to compensate for imperfections in trapping potentials (alternatively, quantum operations can be serialized). Since minimal unit cell geometries typically assume on the order of one qubit per junction, including quantum operation compensation electrodes in each unit cell can result in large electrode and signal overheads. The aforementioned restrictions on ion-to-trap surface distance in areas where operation functions are performed also tend to result in larger RF electrode areas and, therefore, capacitances which in-turn results in larger RF power dissipation which can present other technical difficulties. Also, the minimal unit cell geometry implies that decreasing the distance between junctions to increase sorting speeds simultaneously decreases the distance between quantum operation zones which can increase technical difficulties associated with crosstalk of quantum control fields such as finite laser beam widths, laser scatter from fluorescing ions or the trap surface, or microwave fields.

Therefore, technical problems exist with convention ion traps where sorting class functions and quantum operation class functions are performed in common areas of the ion trap.

Various embodiments provide technical solutions to these technical problems. By separating a quantum object confinement apparatus into sections configured for performing sorting and storing class functions and sections configured for performing quantum operation functions, it is possible to gain several technical advantages, many of which are the converses of the disadvantages of the minimal unit cell geometry. For example, when quantum operation locations are not included in sorting sections, any relevant distance scales in the sorting section may be decreased because there is not contraindication for using smaller quantum object-confinement apparatus surface distances and not as many electrodes are needed to sufficiently control the potential wells. Since sorting functions typically do not require the same amount of control over potential wells as quantum operations do, the confinement apparatus could in principle operate with a smaller number of independent signals and electrodes, assuming that quantum operation locations can be shared in a serialized manner.

By using a smaller quantum object-confinement apparatus surface distance in the sorting section, quantum objects can be stored with a higher density which can lead to faster sorting times and smaller RF electrode footprints which results in a smaller amount of RF power being dissipated. When operation functions are not performed within in the sorting section, larger bandwidth electronics (or looser filtering requirements) can be used to help achieve fast transport speeds with minimal electronic drive complexity. The higher density sorting region can also lead to an overall smaller geometry, possibly alleviating laser scattering issues. By separating the quantum operation locations into an operation section of the confinement apparatus that is physically separated and/or distinct from the sorting section, a larger quantum object-confinement apparatus surface distance can be used in the operation section. The larger quantum object-confinement apparatus surface distance (compared to in the sorting section) can mitigate quantum object heating issues during gating operations and mitigate laser scattering during reading and/or measurement operations. Additionally, the distance between quantum operation locations can be optimized for crosstalk issues without a necessarily proportional increase in the distance scale of the sorting section. If the separated quantum operation locations are used serially, the qubit to quantum operation location ratio can be much larger than one, thereby decreasing the number of electrodes and signals needed to operate all of the quantum operation locations. Thus, various embodiments provide technical improvements to the technical fields of trapped atomic systems and quantum charge-coupled device (QCCD)-based quantum computing.

### Exemplary Controller

Various embodiments provide systems comprising confinement apparatuses 200, 300 that include one or more sorting sections 210, 310 configured for the performance of sorting and storing functions and one or more operation sections configured for the performance of quantum operation functions. In an example embodiment, the system is a quantum charge-coupled device (QCCD)-based quantum computer 110 or other quantum computer. In various embodiments, the system (e.g., quantum computer 110) further comprises a controller 30 configured to control various elements of the system. For example, the controller 30 may be configured to control the voltage sources 50, a cryogenic system and/or vacuum system for controlling the temperature and pressure within the cryogenic and/or vacuum chamber 40, manipulation sources 64 (e.g., 64A, 64B, 64C), active components of beam path systems 66 (e.g., 66A, 66B, 66C), magnetic field sources 70 (e.g., 70A, 70B), and/or other systems controlling the environmental conditions (e.g., temperature, humidity, pressure, magnetic field gradient, and/or the like) within the cryogenic and/or vacuum chamber 40, configured to manipulate and/or cause a controlled evolution of quantum states of one or more quantum objects confined by the confinement apparatus, and/or read and/or detect a quantum state of one or more quantum objects confined by the confinement apparatus.

As shown in FIG. 6, in various embodiments, the controller 30 may comprise various controller elements including one or more processing devices 605, memory 610, driver controller elements 615, a communication interface 620, analog-digital converter elements 625, and/or the like. For example, the one or more processing devices 605 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In an example embodiment, the one or more processing devices 605 of the controller 30 comprises a clock and/or is in communication with a clock. In various embodiments, this clock defines the clock cycles of the system.

For example, the memory 610 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FORAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 610 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 610 (e.g., by a processing device 605) causes the controller 30 to perform one or more steps, operations, processes, procedures and/or the like described herein for controlling one or more components of the quantum computer 110 (e.g., voltages sources 50, manipulation sources 64, magnetic field sources 70, and/or the like) to cause a controlled evolution of quantum states of one or more quantum objects, detect and/or read the quantum state of one or more quantum objects, and/or the like.

In various embodiments, the driver controller elements 615 may include one or more drivers and/or controller elements each configured to control one or more drivers. In various embodiments, the driver controller elements 615 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 605). In various embodiments, the driver controller elements 615 may enable the controller 30 to operate a manipulation source 64. In various embodiments, the drivers may be laser drivers; vacuum component drivers; drivers for controlling the flow of current and/or voltage applied to RF, control, and/or other electrodes (e.g., shim electrodes and/or the like) used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the control electrodes 414, 434 and/or RF electrodes 416, 436. In various embodiments, the controller 30 comprises means for communicating and/or receiving signals from one or more detectors such as optical receiver components (e.g., cameras, MEMs cameras, CCD cameras, photodiodes, photomultiplier tubes, and/or the like) of the optics collection system 80. For example, the controller 30 may comprise one or more analog-digital converter elements 625 configured to receive signals from one or more detectors, optical receiver components, calibration sensors, and/or the like.

In various embodiments, the controller 30 may comprise a communication interface 620 for interfacing and/or communicating with one or more computing entities 10. For example, the controller 30 may comprise a communication interface 620 for receiving executable instructions, command sets, and/or the like from the computing entity 10 and providing output received from the quantum processor 115 (e.g., via the optics collection system 80) and/or the result of a processing the output (received from the quantum processor 115) to the computing entity 10. In various embodiments, the computing entity 10 and the controller 30 may communicate via a direct wired and/or wireless connection and/or one or more wired and/or wireless networks 20.

### Exemplary Computing Entity

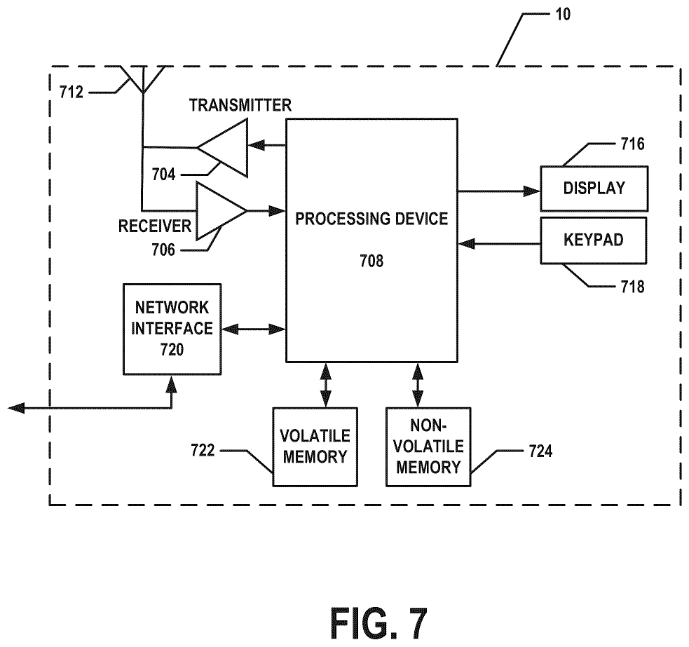

FIG. 7 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 7, a computing entity 10 can include an antenna 712, a transmitter 704 (e.g., radio), a receiver 706 (e.g., radio), and a processing device 708 that provides signals to and receives signals from the transmitter 704 and receiver 706, respectively.

The signals provided to and received from the transmitter 704 and the receiver 706, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibrec, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 further comprises one or more network interfaces 720 configured to communicate via one or more wired and/or wireless networks 20.

The computing entity 10 may also comprise a user interface device comprising one or more user input/output interfaces (E.g., a display 716 and/or speaker/speaker driver coupled to a processing device 708 and a touch screen, keyboard, mouse, and/or microphone coupled to a processing device 708). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 718 (hard or soft), a touch display, voice/speech or motion interfaces, scanners, readers, or other input device. In embodiments including a keypad 718, the keypad 718 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 722 and/or non-volatile storage or memory 724, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A confinement apparatus comprising:
one or more sorting sections; and
an operation section;
wherein each sorting section of the one or more sorting sections comprises a plurality of sorting section radio frequency (RF) rails, the plurality of sorting section RF rails are configured to, when a sorting RF voltage is applied thereto, define a plurality of sorting confinement regions configured for confining quantum objects, and each sorting section RF rail of the plurality of sorting section RF rails has a sorting thickness in a direction perpendicular to a longitudinal axis of the sorting section RF rail,
wherein the operation section comprises a plurality of operation section RF rails, the plurality of operation section RF rails are configured to, when an operation RF voltage is applied thereto, define a plurality of operation confinement regions configured for confining the quantum objects, and each operation section RF rail of the plurality of operation section RF rails has an operation thickness in a direction perpendicular to a longitudinal axis of the operation section RF rail, and
wherein the operation thickness is larger than the sorting thickness.

2. The confinement apparatus of claim 1, wherein the plurality of sorting section RF rails comprises a plurality of parallel pairs of sorting section RF rails that are separated by a sorting separation, the plurality of operation section RF rails comprises a plurality of parallel pairs of operation section RF rails that are separated by an operation separation, and the sorting separation is larger than the operation separation.

3. The confinement apparatus of claim 1, wherein the sorting confinement regions are configured to confine the quantum objects with a quantum object-confinement apparatus surface distance of a sorting distance, the operation confinement regions are configured to confine the quantum objects with a quantum object-confinement apparatus surface distance of an operation distance, and the operation distance is larger than the sorting distance.

4. The confinement apparatus of claim 1, further comprising one or more transition zone, wherein each transition zone of the one or more transition zones is disposed between the operation section and a respective sorting section of the one or more sorting sections.

5. The confinement apparatus of claim 4, wherein the transition zone comprises a plurality of transition RF rails and each transition RF rail of the plurality of transition RF rails has a thickness that changes over the length of the transition RF rail.

6. The confinement apparatus of claim 5, wherein the transition RF rail has a thickness that is (a) substantially equal to the sorting thickness at an edge of the transition zone adjacent the respective sorting section and (b) substantially equal to the operation thickness at an edge of the transition zone adjacent the operation section.

7. The confinement apparatus of claim 5, wherein the plurality of transition RF rails comprises a plurality of parallel pairs of transition RF rails that are separated by (a) a sorting separation at an edge of the transition zone adjacent the respective sorting section and (b) an operation separation at an edge of the transition zone adjacent the operation section.

8. The confinement apparatus of claim 4, wherein the transition zone is configured to cause a quantum object-confinement apparatus surface distance of a quantum object confined by the confinement apparatus to change between (a) a sorting distance when the quantum object is at an edge of the transition zone adjacent the respective sorting section and (b) an operation distance when the quantum object is at an edge of the transition zone adjacent the operation section, wherein the change in the quantum object-confinement apparatus surface distance of the quantum object is adiabatic.

9. The confinement apparatus of claim 1, wherein the sorting section further comprises a plurality of sorting control electrodes configured to be operated in accordance with a first noise tolerance and the operation section comprises a plurality of operation control electrodes configured to be operated in accordance with a second noise tolerance, the first noise tolerance being different from the second noise tolerance.

10. The confinement apparatus of claim 9, wherein the sorting control electrodes comprise a plurality of broadcast control electrodes that are configured to receive respective broadcasted voltage signals.

11. The confinement apparatus of claim 9, wherein a sorting control electrode of the plurality of sorting control electrodes has a sorting width, an operation control electrode of the plurality of operation control electrodes has an operation width, and the operation width is greater than the sorting width.

12. A system comprising:
a plurality of voltage sources;
operation filters;
sorting filters; and
a confinement apparatus configured to confine quantum objects, wherein the confinement apparatus comprises:
one or more sorting sections configured for performing sorting functions on the quantum objects; and
an operation section configured for having quantum operations performed one or more of the quantum objects therein;
wherein each sorting section of the one or more sorting sections comprises a plurality of sorting section radio frequency (RF) rails, the plurality of sorting section RF rails are configured to, when a sorting RF voltage is applied thereto, define a plurality of sorting confinement regions configured for confining the quantum objects, and each sorting section RF rail of the plurality of sorting section RF rails has a sorting thickness in a direction perpendicular to a longitudinal axis of the sorting section RF rail,
wherein the operation section comprises a plurality of operation section RF rails, the plurality of operation section RF rails are configured to, when an operation RF voltage is applied thereto, define a plurality of operation confinement regions configured for confining the quantum objects, and each operation section RF rail of the plurality of operation section RF rails has an operation thickness in a direction perpendicular to a longitudinal axis of the operation section RF rail, and
wherein the operation thickness is larger than the sorting thickness, and
wherein the plurality of voltage sources are configured to generate respective voltage sources that are filtered by a respective filter of the operation filters or the sorting filters, a voltage signal filtered by an operation filter is applied to the plurality of operation RF rails, and a voltage signal filtered by a sorting filter is applied to the plurality of sorting RF rails.

13. The system of claim 12, wherein the sorting filters and the operation filters have different filter responses.

14. The system of claim 12, further comprising one or more manipulation sources and one or more beam path systems, wherein the operation section defines one or more quantum operation locations, and the one or more beam path systems are configured to provide manipulation signals generated by respective manipulation sources of the one or more manipulations sources to respective quantum operation locations.

15. The system of claim 14, wherein the quantum operation locations include gating locations configured for performance of quantum logic operations on one or more quantum objects and measurement locations configured for performance of measurement operations on one or more quantum objects.

16. The system of claim 12, wherein the plurality of sorting section RF rails comprises a plurality of parallel pairs of sorting section RF rails that are separated by a sorting separation, the plurality of operation section RF rails comprises a plurality of parallel pairs of operation section RF rails that are separated by an operation separation, and the sorting separation is larger than the operation separation.

17. The system of claim 12, wherein the sorting confinement regions are configured to confine the quantum objects with a quantum object-confinement apparatus surface distance of a sorting distance, the operation confinement regions are configured to confine the quantum objects with a quantum object-confinement apparatus surface distance of an operation distance, and the operation distance is larger than the sorting distance.

18. The system of claim 12, wherein the confinement apparatus further comprises one or more transition zones, wherein each transition zone of the one or more transition zones is disposed between the operation section and a respective sorting section of the one or more sorting sections.

19. The system of claim 18, wherein the transition zone comprises a plurality of transition RF rails and each transition RF rail of the plurality of transition RF rails has a thickness that changes over the length of the transition RF rail.

20. The system of claim 18, wherein the transition zone is configured to cause a quantum object-confinement apparatus surface distance of a quantum object confined by the confinement apparatus to change between (a) a sorting distance when the quantum object is at an edge of the transition zone adjacent the respective sorting section and (b) an operation distance when the quantum object is at an edge of the transition zone adjacent the operation section, wherein the change in the quantum object-confinement apparatus surface distance of the quantum object is adiabatic.
